(19) United States
(12) Patent Application Publication
(10) Pub. No.: US 2006/0103683 A1
(43) Pub. Date: May 18, 2006

(54) Method and system for gamma adjustment of display apparatus

(76) Inventor: Ho-woong Kang, Yongin-si (KR)

Correspondence Address: STANZIONE & KIM, LLP, 919 18TH STREET, N.W., SUITE 440, WASHINGTON, DC, 20006, US

(21) Appl. No.: 11/272,139

(22) Filed: Nov. 14, 2005

(30) Foreign Application Priority Data
Nov. 17, 2004 (KR) 2004-94320

(51) Int. Cl. G09G 5/10

(52) U.S. Cl. 345/690

(57) ABSTRACT

A method for gamma adjustment of a display apparatus having a gamma transform table for an input signal, the method including selecting a plurality of sample gray levels among gray levels of the input signal; measuring a brightness level of an output video signal with regard to the plurality of selected sample gray levels; determining first gamma transform values corresponding to the sample gray levels on the basis of the measured brightness level, and storing the determined gamma transform values; calculating second gamma transform values corresponding to the gray levels of the input signal excluding the sample gray level on the basis of the gamma transform values corresponding to the sample gray levels; and setting the gamma transform table on the basis of the stored first gamma transform value and the calculated second gamma transform value. Accordingly, it is an aspect of the present invention to provide a method and a system for gamma adjustment of a display apparatus capable of processing a digital signal, in which uniform color temperature is representable by adjusting R, G and B gamma curves properly in a sampling method, departing from the conventional color temperature adjustment for a CRT display apparatus.

### CROSS-REFERENCE TO RELATED APPLICATIONS

This application claims the benefit of Korean Patent Application No. 2004-0094320, filed on Nov. 17, 2004, in the Korean Intellectual Property Office, which is hereby incorporated by reference for all purposes as if fully set forth herein.

### BACKGROUND OF THE INVENTION

1. Field of the Invention

The present invention relates to a method and a system for gamma adjustment of a display apparatus, and more particularly, to a method and a system for gamma adjustment of a display apparatus, in which color temperature is adjusted by adjusting a red, green and blue (RGB) gamma curve.

2. Description of the Related Art

Picture quality is directly affected in most display apparatuses by white balance that can be adjusted through color temperature dominating color sensitivity of the entire display screen. The color temperature adjustment is considered when many types of display apparatuses are manufactured. The color temperature refers to the color sensitivity of achromatic color, e.g., most blacks, whites, and grays, with regard to all brightness levels.

Display apparatuses have different R, G, and B cutoff point and/or electron beam intensify to determine the color temperature with regard to the brightness level.

Conventional cathode ray tube (CRT) display apparatuses have -R, G and B electron guns with different properties, such as a cutoff point where no electron beam flows, i.e., an electron beam emission critical point, and electron beam intensity. Therefore, when R, G and B analog signals are applied to the CRT display apparatus, R, G and B colors are balanced by adjusting the respective cutoff levels and gains, so that the color temperature of the whole screen is determined by applying a predetermined rate thereto. In the case of the CRT display apparatus, the color temperature is substantially uniform with regard to all brightness levels.

However, in the case of a digital signal processing type display apparatus, such as a liquid crystal display (LCD), a plasma display panel (PDP) or the like, the R, G and B cutoff points are similar, and only the intensity is different according to R, G and B colors. At this time, when the size of the RGB digital signal is adjusted to change the RGB color intensity to a predetermined target value, the number of representable colors decreases, therefore, contrary to the CRT display the color temperature is not uniform with regard to all brightness levels.

In FIG. 1, (a) shows RGB output levels corresponding to input signal levels when gamma transform is implemented under a bypass condition, and (b) shows a trajectory of the color temperature based on the RGB output levels with regard to the brightness. Referring to (a) and (b), when the gamma transform is implemented under the bypass condition, the color temperature is not uniform with respect to the brightness.

In FIG. 1, (c) shows the RGB output levels obtained by applying different gamma transforms to the respective input signal levels to make the color temperature uniform according to brightness, and (d) shows the trajectory of the color temperature based on the RGB output levels with regard to brightness. Referring to (c) and (d), when the gamma transform is implemented differently according to the input signal levels, the color temperature is relatively uniform with respect to the brightness.

However, to obtain the foregoing results, gamma transform values should be adjusted individually according to the input signal levels. For example, when R, G and B digital signals each having 8 bits are processed, the number of input signal levels is 256, so that the gamma adjustment should be implemented by total 256 times to search proper conditions for R, G and B gamma transform according to the input signal levels. Current technology makes it difficult and impractical due to time and cost to implement the gamma adjustment 256 times. Further, measurement errors increase when the brightness level is in a color temperature relatively low or high, making gamma adjustment difficult.

### SUMMARY OF THE INVENTION

Accordingly, it is an aspect of the present invention to provide a method and a system for gamma adjustment of a display apparatus capable of processing a digital signal, in which uniform color temperature is representable by adjusting R, G and B gamma curves properly in a sampling method, departing from the conventional color temperature adjustment for a CRT display apparatus.

Additional aspects and/or advantages of the invention will be set forth in part in the description which follows and, in part, will be apparent from the description, or may be learned by practice of the invention.

The foregoing and/or other aspects of the present invention are also achieved by providing a method of gamma adjustment for a display apparatus having a gamma transform table for an input signal, comprising: selecting a plurality of sample gray levels among gray levels of the input signal; measuring a brightness level of an output video signal with regard to the plurality of selected sample gray levels; determining first gamma transform values corresponding to the sample gray levels on the basis of the measured brightness level, and storing the determined gamma transform values; calculating second gamma transform values corresponding to the gray levels of the input signal, excluding the sample gray level, on the basis of the stored gamma transform values; and setting the gamma transform table on the basis of the stored first gamma transform value and the calculated second gamma transform value.

According to an aspect of the present invention, the calculating the second gamma transform value comprises using interpolation or an average increase/decrease rate to calculate the second gamma transform value on the basis of the first gamma transform value.

According to an aspect of the present invention, the calculating the second gamma transform value comprises using a previously statistically analyzed value to calculate the second gamma transform value with regard to a predetermined range of the gray levels excluding the sample gray levels.

According to an aspect of the present invention, the second gamma transform value is calculated by following equations:
D_{LE}=(Dₙ/Dₙ₊₁+Dₙ₊₁/Dₙ₊₂+ . . . +Dₙ₊ₘ/Dₙ₊ₘ₊₁)/m,
dₖ₋₁=dₖ−Dₖ×D_{LE}×C_{L}(%)

wherein D_{LE} is an average increase/decrease rate in a predetermined range of the sample gray level; Dₖ is an increase/decrease rate of the gamma transform value corresponding to the k^{th} sample gray level; and C_{L}(%) is a statistically analyzed value of a predetermined range of the input signal.

According to an aspect of the present invention, the second gamma transform value is calculated by following equation:
dₜ₊₁=dₜ+Dₜ/N

wherein ‘dₜ’ is an R, G or B gamma transform value due to gamma adjustment with regard to the t^{th} sample gray level; Dₜ is an increase/decrease rate of the gamma transform value corresponding to the t^{th} sample gray level; and N is the number of non-adjustable gray levels between the sample gray levels corresponding to the calculated Dₜ.

According to an aspect of the present invention, the calculating the second gamma transform value comprises using a previously statistically analyzed value to calculate the second gamma transform value with regard to a predetermined range of the gray levels excluding the sample gray levels.

According to an aspect of the present invention, the second gamma transform value is calculated by the following equations:
D_{LE}=(Dₙ/Dₙ₊₁+Dₙ₊₁/Dₙ₊₂+ . . . +Dₙ₊ₘ/Dₙ₊ₘ₊₁)/m,
dₖ₋₁=dₖ−Dₖ×D_{LE}×C_{L}(%)

wherein D_{LE} is an average increase/decrease rate in a predetermined range of the sample gray level;

Dₖ is an increase/decrease rate of the gamma transform value corresponding to the k^{th} sample gray level; and

C_{L}(%) is a statistically analyzed value of a predetermined range of the input signal.

The foregoing and/or other aspects of the present invention are also achieved by providing a system for gamma adjustment of a display apparatus comprising a gamma transform table set with a gamma transformivalue for an input signal, and a gamma transformer to apply gamma transform to the input signal on the basis of the gamma transform table, the system comprising: a controller selecting a plurality of sample gray levels among gray levels of the input signal, wherein the controller measures a brightness level of an output video signal with regard to the plurality of selected sample gray levels, determines first gamma transform values corresponding to the sample gray levels on the basis of the measured brightness level, and stores the determined gamma transform values, calculates second gamma transform values corresponding to the gray levels of the input signal excluding the sample gray level on the basis of the gamma transform values corresponding to the sample gray levels, and sets the gamma transform table on the basis of the stored first gamma transform value and the calculated second gamma transform value.

According to an aspect of the present invention, the controller comprises: a brightness measurer to measure the brightness level of the output video signal with regard to the plurality of selected sample gray levels; a sample analyzer to determine the first gamma transform values corresponding to the sample gray levels on the basis of the measured brightness level; an operator to calculate the second gamma transform values corresponding to the gray levels of the input signal excluding the sample gray level on the basis of the gamma transform values corresponding to the sample gray levels, and set the gamma transform table on the basis of the stored first gamma transform value and the calculated second gamma transform value.

According to an aspect of the present invention, the operator either uses interpolation or an average increase/decrease rate to calculate the second gamma transform value corresponding to the gray levels of the input signal excluding the sample gray level on the basis of the first gamma transform value corresponding to the sample gray level.

According to an aspect of the present invention, the operator uses a previously statistically analyzed value to calculate the second gamma transform value with regard to a predetermined range of the gray levels excluding the sample gray levels.

According to an aspect of the present invention, the operator uses a previously statistically analyzed value to calculate the second gamma transform value with regard to a predetermined range of the gray levels excluding the sample gray levels.

According to an aspect of the present invention, the second gamma transform value is calculated by following equations:
D_{LE}=(Dₙ/Dₙ₊₁+Dₙ₊₁/Dₙ₊₂+ . . . +Dₙ₊ₘ/Dₙ₊ₘ₊₁)/m,
dₖ₋₁=dₖ−Dₖ×D_{LE}×C_{L}(%)

wherein D_{LE} is an average increase/decrease rate in a predetermined range of the sample gray level; Dₖ is an increase/decrease rate of the gamma transform value corresponding to the k^{th} sample gray level; and C_{L}(%) is a statistically analyzed value of a predetermined range of the input signal.

According to an aspect of the present invention, the second gamma transform value is calculated by following equation:
dₜ₊ₗ=dₜ+Dₜ/N

wherein ‘dₜ’ is an R, G or B gamma transform value due to gamma adjustment with regard to the t^{th} sample gray level; Dₜ is an increase/decrease rate of the gamma transform value corresponding to the t^{th} sample gray level; and N is the number of non-adjustable gray levels between the sample gray levels corresponding to the calculated Dₜ.

According to an aspect of the present invention, the second gamma transform value is calculated by the following equations:
D_{LE}=(Dₙ/Dₙ₊₁+Dₙ₊₁/Dₙ₊₂+ . . . +Dₙ₊ₘ/Dₙ₊ₘ₊₁)/m,
dₖ₋₁=dₖ−Dₖ×D_{LE}×C_{L}(%)

wherein D_{LE} is an average increase/decrease rate in a predetermined range of the sample gray level; Dₖ is an increase/decrease rate of the gamma transform value corresponding to the k^{th} sample gray level; and C_{L}(%) is a statistically analyzed value of a predetermined range of the input signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates graphs of output levels corresponding to input levels in a conventional gamma adjustment method for a display apparatus.

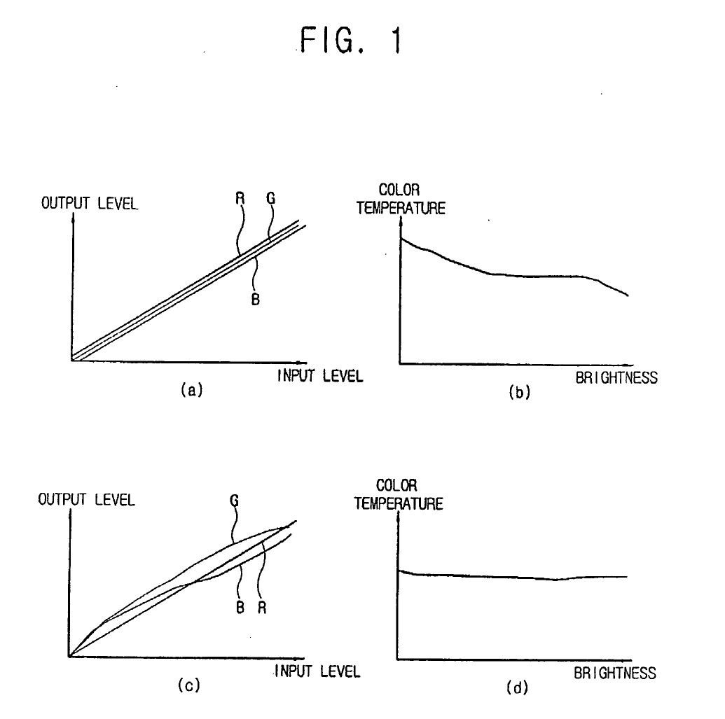

FIG. 2 is a control block diagram of a gamma adjustment system of a display apparatus according to an embodiment of the invention.

FIG. 3 is a control flowchart of a gamma adjustment method for the display apparatus according to an embodiment of the invention.

FIG. 4 is a graph obtained by the gamma adjustment method for the display apparatus according to an embodiment of the invention.

### DETAILED DESCRIPTION OF THE ILLUSTRATED EMBODIMENTS

Reference will now be made in detail to the embodiments of the invention, examples of which are illustrated in the accompanying drawings, wherein like reference numerals refer to like elements throughout.

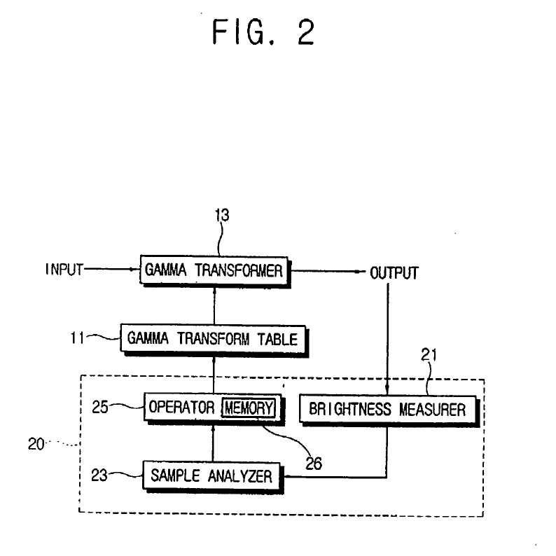

FIG. 2 is a control block diagram of a gamma transform system for a display apparatus capable of processing a digital signal according to an embodiment of the invention. As shown in FIG. 2, a gamma transform system for a display apparatus capable of processing a digital signal includes a gamma transform table 11 set with a gamma transform value corresponding to an input signal, a gamma transformer 13 to gamma-transform the input signal on the basis of the gamma transform table 11, and a controller 20 to determine the gamma transform value by measuring brightness of a video signal outputted at a sample gray level, and set the gamma transform table 11 by calculating the gamma transform value at a non-adjustable gray level on the basis of the determined gamma transform value.

Here, the controller 20 may include a brightness measurer 21, a sample analyzer 23, and an operator 25.

The brightness measurer 21 is used for measuring video data outputted to a display panel, and may include a color analyzer or checker to measure the brightness or color coordinates of a picture by optically measuring the picture displayed on the display panel.

The sample analyzer 23 outputs a command to the display apparatus to transmit an input signal corresponding to the sample gray level to the display apparatus.

According to an embodiment of the invention, the sample analyzer 23 may directly output the command to an internal microcomputer of the display apparatus without passing through an input terminal of the display apparatus. The microcomputer receives the command output from the sample analyzer 23 and controls a scaler (not shown) to sequentially display a pattern corresponding to the gray level that is provided in the scaler, on the display panel, thereby displaying a level of the input signal according to the command. Therefore, it is possible to adjust color temperature without having a separate device process the input signal.

The sample analyzer 23 may be realized by a computer connected and operating with the display apparatus on an inspection process line and adjusts an output according to the input signal.

The sample analyzer 23 adjusts the gamma transform value according to the data measured by the brightness measurer 21 and determines the gamma transform values corresponding to the respective sample gray levels, thereby allowing the video signal to be outputted having a target level. The determined gamma transform value is inputted to the operator 25 and the operator 25 calculates the gamma transform values corresponding to the non-adjustable gray levels excluding the sample gray levels on the basis of the determined gamma transform value. The sample analyzer 23 is connected with the brightness measurer 21 and reads out or outputs the measured data from the brightness measurer 21. Further, the sample analyzer 23 is connected with the operator 25 via a wire or wireless connection, and transmits the determined gamma transform value corresponding with the sample gray levels to the operator 25.

The sample analyzer 23 may be previously set for the plurality of sample gray levels among all representable gray levels of the display apparatus. Alternatively, the sample gray levels may be variously set by a user with regard to the selection and the order of the gray level according to, for example, a program or algorithm.

The sample gray levels may be previously set as a program in the sample analyzer 23. For example, ten or twenty sample gray levels may be previously set from among the 256 gray levels. The sample gray levels may be selected according to the inspection process. Alternatively, the sample gray levels may be set to account for errors in the brightness measured by the brightness measurer 21, such as when there is a relatively low or high brightness.

Also, when each of R, G and B video signals is processed as 8 bits and they each have 256 gray levels, 80 gray levels corresponding to each of high and low gray levels are excluded from the 256 gray levels, and the other gray levels are equivalently divided into nine levels and set as the sample gray levels. Further, in the respective excluded gray levels corresponding to the high and low gray levels, 30 gray levels closely related to the middle gray level can be divided into seven levels and then finely adjusted without adjusting the other 50 gray levels.

The high and low gray levels are required to be more finely adjusted because the brightness measured by the brightness measurer 21 includes greater error in the low and high gray levels, making it difficult to adjust the gray level.

In a non-limiting example, when the foregoing sampling method is approximately applied to 64 gray levels, 12^{th}, 13^{th}, 14^{th}, 15^{th}, 16^{th}, 17^{th}, 18^{th}, 21^{st}, 24^{th}, 24^{th}, 27^{th}, 30^{th}, 33^{th}, 36^{th}, 39^{th}, 42^{nd}, 45^{th}, 48^{th}, 49^{th}, 50^{th}, 51^{st}, 52^{nd}, 53^{rd}, 54^{th} gray levels among total 64 gray levels are sampled.

The operator 25 calculates an approximate value of the gamma transform value corresponding to the non-adjustable gray level on the basis of the gamma transform value corresponding with the sample gray level determined by the sample analyzer 23, and then sets the gamma transform table 11 with the calculated approximate value.

According to an embodiment of the invention, the operator 25 may be realized by the microcomputer internally provided in the display apparatus. The operator 25 stores the gamma transform value corresponding with the sample gray level determined by the sample analyzer 23 in its own memory 26 or a separate memory, and then calculates the gamma transform value corresponding to the non-adjustable gray level on the basis of the stored gamma transform value corresponding to the sample gray level.

In this case, the memory 26 may be realized by a read only memory (ROM), an electrically programmable read only memory (EPROM), an electrically erasable and programmable read only memory (EEPROM), or the like.

In the meanwhile, calculations such as interpolation, an average increase/decrease rate between the sample gray levels, a statistical analysis value, etc., may be used for calculating the gamma transform vale corresponding to the non-adjustable gray level on the basis of the gamma transform value corresponding to the sample gray level stored in the memory 26.

During interpolation, for example, when 23 sample gray levels are set, the non-adjustable gray level between the corresponding sample gray levels is calculated as the most approximate value according to the gamma transform values corresponding to both sample gray levels.

When using the average increase/decrease rate, the gamma transform value corresponding to the non-adjustable gray level is calculated using the following equation 1.
dₜ₊₁=dₜ+Dₜ/N [Equation 1]

where ‘dₜ’ is an R, G or B gamma transform value due to gamma adjustment with regard to the t^{th} sample gray level; Dₜ is an increase/decrease rate of the gamma transform value corresponding to the t^{th} sample gray level; and N is the number of non-adjustable gray levels between the sample gray levels corresponding to the calculated Dₜ.

The gamma transform value is then compensated according to statistical results previously processed with regard to a predetermined level range of the input signal, which is calculated as follows.
D_{LE}=(Dₙ/Dₙ₊₁+Dₙ₊₁/Dₙ₊₂+ . . . +Dₙ₊ₘ/Dₙ₊ₘ₊₁)/m, [Equation 2]
dₖ₋₁=dₖ−Dₖ×D_{LE}×C_{L}(%) [Equation 3]

where D_{LE} is the average increase/decrease rate of a predetermined range of the sample gray level; Dₖ is an increase/decrease rate of the gamma transform value in the k^{th} sample gray level; and C_{L}(%) is a statistically analyzed value of a predetermined gray level range of the input signal.

In the foregoing equations, the predetermined range refers to a range that is near to the level corresponding to each of the highest and lowest 20% gray levels.

For example, the gamma transform value is calculated according to both the minimum gamma transform value of the sample gray level and the average increase/decrease rate between approximately 20 to 30% of the gray levels near to the lowest 20% of the gray levels, without applying the sampling method to the input gray levels corresponding to the lowest 20% of the gray levels. This compensation method compensates for the error in measuring the low and high brightness.

The statistically analyzed value C_{L}(%) is calculated as a percentage to compensate the gamma transform value in the low or high brightness level. Here, for example, the statistically analyzed value C_{L}(%) ranges between 0% and 200%, which is calculated as the percentage according to adjustment data for the high and low brightness in a plurality of display apparatuses.

Therefore, for the high and low brightness levels that are difficult to adjust due to measuring error, the gamma transform value thereof is compensated for according to the statistically analyzed value C_{L}(%), so that the color temperature may be uniformly represented, thereby suitably adjusting a white balance of the display apparatus.

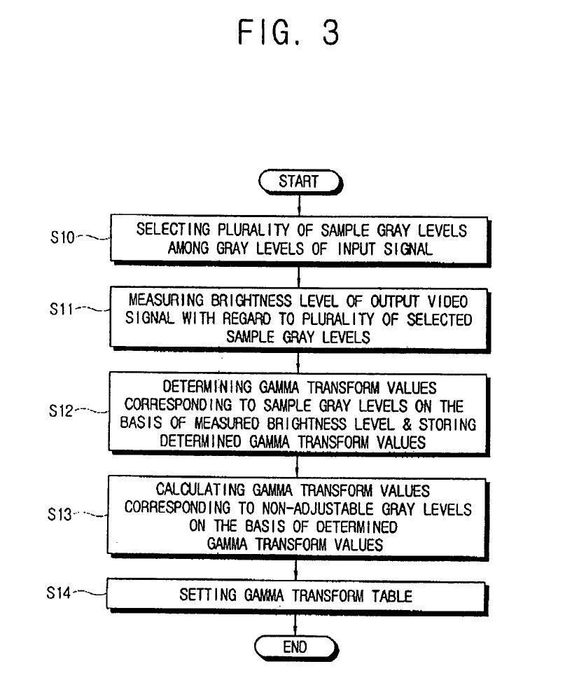

The gamma transform for the display apparatus is described below with reference to FIG. 3.

Referring to FIG. 3, at operation S10, the plurality of sample gray levels are selected from the gray levels of the input signal.

The sample analyzer 23 subsequently outputs the command to the microcomputer of the display apparatus so that the input video signals corresponding to the plurality of sample gray levels are transmitted to the display panel. Here, the microcomputer controls the scaler to output an internal pattern corresponding to the gray levels. At operation S11, the brightness measurer 21 optically measures the output video signal, and measures the color coordinates and the brightness level of the output video signal.

At operation S12, the sample analyzer 23 performs the gamma adjustment so that a target brightness value is output according to the measured brightness level, thereby determining the gamma transform value corresponding with the sample gray level and storing it in the operator 25. Thus, when the gamma adjustment is finished with regard to the previously set sample gray levels, the gamma transform value of the sample gray level is stored in the memory 26.

At operation S13, the operator 25 calculates the gamma transform value corresponding to the non-adjustable gray level of the input signal excluding the sample gray level on the basis of the stored gamma transform value according to a predetermined operation for calculating the gamma transform value.

For example, when using the internal pattern of the scaler, the patterns corresponding to the sample gray levels that total 64 gray levels are displayed and then 23 levels are adjusted. Further, when processing R, G and B video signals that each have 9 bits, the gamma transform values of the other 489 levels among 512 levels are calculated by a predetermined operation.

The predetermined operation for calculating the gamma transform value is programmed in the operator 25. The operation is described as above.

At operation S14, the operator 25 sets the gamma transform table 11 with the gamma transform value corresponding to the sample gray level, which is stored in the memory 26, and the gamma transform value corresponding to the non-adjustable gray level, which is calculated by the foregoing operation.

At this time, whenever the display apparatus is turned on, the gamma transform value corresponding to the non-adjustable gray level is calculated by a corresponding program on the basis of the gamma transform value corresponding to the sample gray level stored in the memory 26, thereby setting the gamma transform table 11 with the calculated gamma transform values at operation S14. Further, various gray levels, such as 256 levels, 512 levels, or the like, may be representable according to a type of display apparatus, so that the gamma transform table 11 may be set with the gray level set in the display apparatus on the basis of the gamma transform value corresponding to the minimum level stored in the memory 26.

Thus, according to an embodiment of the invention, the gamma adjustment is not implemented for all gray levels, and the gamma adjustment is implemented by the sampling method that calculates the approximate gamma transform value corresponding to the non-adjustable gray level.

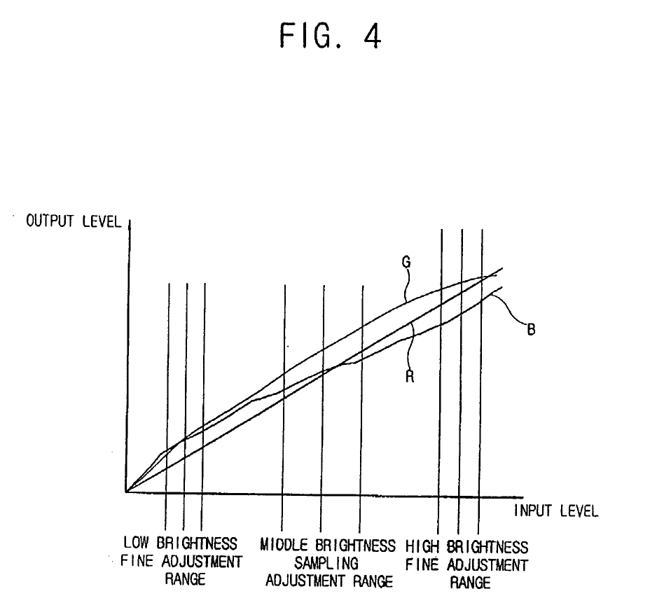

FIG. 4 is a graph obtained by the gamma adjustment method for the display apparatus according to an embodiment of the invention.

Referring to FIG. 4, the sample gray level has nine levels, wherein the middle brightness is adjusted in a three levels that are wider than the levels of the high and low brightness, which are relatively finely adjusted.

Here, the gamma transform values corresponding to the non-adjustable gray levels beyond the minimum level among the sample gray levels deviated from the low brightness fine adjustment range are calculated by the equation 3 on the basis of the gamma transform value corresponding to the minimum sample gray level, and the statistically analyzed value and the average increase/decrease rate of the low brightness fine adjustment range. Likewise, the gamma transform values corresponding to the non-adjustable gray levels beyond the maximum level among the sample gray levels deviated from the high brightness fine adjustment range are calculated by the equation 3 on the basis of the gamma transform value corresponding to the minimum sample gray level, and the statistically analyzed value and the average increase/decrease rate of the high brightness fine adjustment range.

Therefore, the gamma adjustment may be implemented to make the color temperature uniform according to the properties of the display apparatus.

Meanwhile, when a liquid crystal display (LCD) is employed, the R, G and B color temperatures are adjusted with regard to each sample level and increased/decreased by one level. The response speed of liquid crystal is slow with regard to fine variables corresponding to hundreds of mS. Therefore, when the sample analyzer 23 outputs the command corresponding to the input signal, the sample gray level is preferably, but not necessarily, adjusted in an order of 12→33→13→36 . . . , e.g., in the case of 64 gray levels.

Further, while the gamma adjustment may implemented, one of R, G and B color temperatures should be fixed. At this time, the fixed color temperature may vary according to the properties of the display panel.

Further, the present invention can use Y gamma. At this time, a gamma curve is set as an initial value with regard to each sample gray level of all colors, and the gamma adjustment is implemented.

Further, the gamma transform method of the display apparatus according to an embodiment of the invention may be programmed to be automatically implemented in a factory mode. Alternatively, the gamma adjustment may be manually implemented.

Further, the present invention is applicable to any display apparatus that is able to process a digital signal.

As described above, the present invention provides a method and a system for gamma adjustment of a display apparatus capable of processing a digital signal, in which uniform color temperature is represented by adjusting R, G and B gamma curves properly according to products in a sampling method, departing from the conventional color temperature adjustment for a CRT display apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of gamma adjustment for a display apparatus having a gamma transform table for an input signal, comprising:
selecting a plurality of sample gray levels among gray levels of the input signal;
measuring a brightness level of an output video signal with regard to the plurality of selected sample gray levels;
determining first gamma transform values corresponding to the sample gray levels on the basis of the measured brightness level, and storing the determined gamma transform values;
calculating second gamma transform values corresponding to the gray levels of the input signal, excluding the sample gray level, on the basis of the stored gamma transform values; and
setting the gamma transform table on the basis of the stored first gamma transform value and the calculated second gamma transform value.

2. The method of claim 1, wherein the calculating the second gamma transform value comprises using interpolation or an average increase/decrease rate to calculate the second gamma transform value on the basis of the first gamma transform value.

3. The method of claim 2, wherein the calculating the second gamma transform value comprises using a previously statistically analyzed value to calculate the second gamma transform value with regard to a predetermined range of the gray levels excluding the sample gray levels.

4. The method of claim 3, wherein the second gamma transform value is calculated by following equations:
DLE=(Dn/Dn+1+Dn+1/Dn+2+ . . . +Dn+m/Dn+m+1)/m,
dk−1=dk−Dk×DLE×CL(%)
wherein DLE is an average increase/decrease rate in a predetermined range of the sample gray level;
Dk is an increase/decrease rate of the gamma transform value corresponding to the kth sample gray level; and
CL(%) is a statistically analyzed value of a predetermined range of the input signal.

5. The method of claim 2, wherein the second gamma transform value is calculated by following equation:
dt+1=dt+Dt/N
wherein ‘dt’ is an R, G or B gamma transform value due to gamma adjustment with regard to the tth sample gray level;
Dt is an increase/decrease rate of the gamma transform value corresponding to the tth sample gray level; and
N is the number of non-adjustable gray levels between the sample gray levels corresponding to the calculated Dt.

6. The method of claim 1, wherein the calculating the second gamma transform value comprises using a previously statistically analyzed value to calculate the second gamma transform value with regard to a predetermined range of the gray levels excluding the sample gray levels.

7. The method of claim 6, wherein the second gamma transform value is calculated by the following equations:
DLE=(Dn/Dn+1+Dn+1/Dn+2+ . . . +Dn+m/Dn+m+1)/m,
dk−1=dk−Dk×DLE×CL(%)
wherein DLE is an average increase/decrease rate in a predetermined range of the sample gray level;
Dk is an increase/decrease rate of the gamma transform value corresponding to the kth sample gray level; and
CL(%) is a statistically analyzed value of a predetermined range of the input signal.

8. A system for gamma adjustment of a display apparatus comprising a gamma transform table set with a gamma transform value for an input signal, and a gamma transformer to apply gamma transform to the input signal on the basis of the gamma transform table, the system comprising:
a controller selecting a plurality of sample gray levels among gray levels of the input signal,
wherein the controller measures a brightness level of an output video signal with regard to the plurality of selected sample gray levels, determines first gamma transform values corresponding to the sample gray levels on the basis of the measured brightness level, and stores the determined gamma transform values, calculates second gamma transform values corresponding to the gray levels of the input signal excluding the sample gray level on the basis of the gamma transform values corresponding to the sample gray levels, and sets the gamma transform table on the basis of the stored first gamma transform value and the calculated second gamma transform value.

9. The system of claim 8, wherein the controller comprises:
a brightness measurer to measure the brightness level of the output video signal with regard to the plurality of selected sample gray levels;
a sample analyzer to determine the first gamma transform values corresponding to the sample gray levels on the basis of the measured brightness level;
an operator to calculate the second gamma transform values corresponding to the gray levels of the input signal excluding the sample gray level on the basis of the gamma transform values corresponding to the sample gray levels, and set the gamma transform table on the basis of the stored first gamma transform value and the calculated second gamma transform value.

10. The system of claim 9, wherein the operator either uses interpolation or an average increase/decrease rate to calculate the second gamma transform value corresponding to the gray levels of the input signal excluding the sample gray level on the basis of the first gamma transform value corresponding to the sample gray level.

11. The system of claim 10, wherein the operator uses a previously statistically analyzed value to calculate the second gamma transform value with regard to a predetermined range of the gray levels excluding the sample gray levels.

12. The system of claim 9, wherein the operator uses a previously statistically analyzed value to calculate the second gamma transform value with regard to a predetermined range of the gray levels excluding the sample gray levels.

13. The system of claim 10, wherein the second gamma transform value is calculated by following equations:
DLE=(Dn/Dn+1+Dn+1/Dn+2+ . . . +Dn+m/Dn+m+1)/m,
dk−1=dk−Dk×DLE×CL(%)
wherein DLE is an average increase/decrease rate in a predetermined range of the sample gray level;
Dk is an increase/decrease rate of the gamma transform value corresponding to the kth sample gray level; and
CL(%) is a statistically analyzed value of a predetermined range of the input signal.

14. The method of claim 11, wherein the second gamma transform value is calculated by following equation:
dt+1=dt+Dt/N
wherein ‘dt’ is an R, G or B gamma transform value due to gamma adjustment with regard to the tth sample gray level;
Dt is an increase/decrease rate of the gamma transform value corresponding to the tth sample gray level; and
N is the number of non-adjustable gray levels between the sample gray levels corresponding to the calculated Dt.

15. The method of claim 12, wherein the second gamma transform value is calculated by the following equations:
DLE=(Dn/Dn+1+Dn+1/Dn+2+ . . . +Dn+m/Dn+m+1)/m,
dk−1=dk−Dk×DLE×CL(%)
wherein DLE is an average increase/decrease rate in a predetermined range of the sample gray level;
Dk is an increase/decrease rate of the gamma transform value corresponding to the kth sample gray level; and
CL(%) is a statistically analyzed value of a predetermined range of the input signal.
